(19) United States
(12) Patent Application Publication
(10) Pub. No.: US 2025/0314939 A1
(43) Pub. Date: Oct. 9, 2025

(54) GRADIENT ELECTROCHROMIC DEVICE AND METHOD OF MANUFACTURING SAID DEVICE

(71) Applicant: SAGE ELECTROCHROMICS, INC., Faribault, MN (US)

(72) Inventors: Yan WANG, Lakeville, MN (US); Theo Nathan Ferdinand CHEVALLIER, Minneapolis, MN (US); Bolei DI, Woodbury, MN (US); Peter E. BOCEK, Burnsville, MN (US); Cody Daniel VanDerVeen, Faribault, MN (US)

(21) Appl. No.: 18/941,073

(22) Filed: Nov. 8, 2024

Related U.S. Application Data
(60) Provisional application No. 63/598,021, filed on Nov. 10, 2023.

(51) Int. Cl. G02F 1/155; G02F 1/1341; G02F 1/1523

(52) U.S. Cl. CPC G02F 1/155; G02F 1/1341; G02F 1/1523

(57) ABSTRACT

A method of manufacturing one or more electroactive devices is disclosed. The method of manufacturing one or more electroactive devices can include creating a continuous electrical isolation line in a first conductive layer around substantially an entire perimeter of a substrate and depositing an electroactive material and a second conductive layer over the formed first conductive layer to form one or more electroactive devices on the substrate.

### CROSS-REFERENCE TO RELATED APPLICATION(S)

This application claims priority under 35 U.S.C. § 119(e) to U.S. Provisional Application No. 63/598,021, entitled “GRADIENT ELECTROCHROMIC DEVICE AND METHOD OF MANUFACTURING SAID DEVICE,” by Yan WANG et al., filed Nov. 10, 2023, which is assigned to the current assignee hereof and incorporated herein by reference in its entirety.

### BACKGROUND

The present disclosure is directed to electroactive devices, and more specifically to apparatuses including electrochromic devices and method of using the same.

An electrochromic device can reduce the amount of sunlight entering a room or passenger compartment of a vehicle. Conventionally, an electrochromic device can be at a particular transmission state. For example, the electrochromic device may be set to a certain tint level (i.e., a percentage of light transmission through the electrochromic device), such as full tint (e.g., 0% transmission level), full clear (e.g., 63% +/−10% transmission level), or a set tint level (or transmission level) in between the two. Tinting electrochromic devices to various tinting patterns depends on several factors of which being able to maintain electrical isolation in view of bus bar placement is among one of the most important. However, with the complexities of bus bar designs maintaining electrical isolation has brought additional challenges that drive the cost of manufacturing up. Further improvement in device manufacturing of an electrochromic device is desired.

### BRIEF DESCRIPTION OF THE DRAWINGS

Embodiments are illustrated by way of example and are not limited in the accompanying figures.

FIG. 1 includes an illustration of a top view of a previous manufacturing method of electroactive devices capable of being maintained at a continuously graded transmission state.

FIG. 2 includes an illustration of a top view of a substrate for forming one or more electroactive devices capable of being maintained at a continuously graded transmission state, according to one embodiment.

FIGS. 3A-3C include illustrations of cross-sectional views of a substrate during various states of manufacturing, according to one embodiment.

FIG. 4 includes an illustration of a top view of a substrate for forming one or more electroactive devices capable of being maintained at a continuously graded transmission state, according to one embodiment.

FIG. 5 includes an illustration of a cross-sectional of an insulated glass unit (IGU).

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

When referring to variables, the term “steady state” is intended to mean that an operating variable is substantially constant when averaged over 10 seconds, even though the operating variable may be changed during a transient state. For example, when in a steady state, an operating variable may be maintained within 10%, within 5%, or within 0.9% of an average for the operating variable for a particular mode of operation for a particular device. Variations may be due to imperfections in an apparatus or supporting equipment, such as noise transmitted along voltage lines, switching transistors within a control device, operating other components within an apparatus, or other similar effects. Still further, a variable may be changed for a microsecond each second, so that a variable, such as voltage or current, may be read; or one or more of the voltage supply terminals may alternate between two different voltages (e.g., V1 and V2) at a frequency of 1 Hz or greater. Thus, an apparatus may be at a steady state even with such variations due to imperfections or when reading operating parameters. When changing between modes of operation, one or more of the operating variables may be in a transient state. Examples of such variables can include voltages at particular locations within an electrochromic device or current flowing through the electrochromic device.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

Many different patterns for the transmission states of an electrochromic device can be achieved by the proper selection of bus bar location, the number of voltage supply terminals coupled to each bus bar, locations of voltage supply terminals along the bus bars, or any combination thereof. Varying locations of the bus bars can provide voltages that can range from fully clear (highest transmission or fully bleached) to fully tinted (lowest transmission state), or anything in between, such as a continuously graded transmission state. The electrochromic device can be used as part of a window for a building or a vehicle or other applications that can benefit from a controllable tinting, such as partitions that separate living spaces or office spaces. The electrochromic device can be used within an apparatus. The apparatus can further include an energy source, an input/output unit, and a control device that controls the electrochromic device. Components within the apparatus may be located near or remotely from the electrochromic device. In an embodiment, one or more of such components may be integrated with environmental controls within a building.

An electrochromic device can operate with voltages on bus bars being in a range of 0 V to 50 V. In one embodiment, the voltages can be between 0 V and 25 V. In another embodiment, the voltages can be between 0 V and 10 V. In yet another embodiment, the voltages can be between 0 V and 3 V. Such description is used to simplify concepts as described herein. Other voltages may be used with the electrochromic device, such as if the composition or thicknesses of layers within an electrochromic stack are changed. The voltages on bus bars may both be positive (0.1 V to 50 V), both negative (−50 V to −0.1 V), or a combination of negative and positive voltages (−1 V to 2 V), as the voltage difference between bus bars is more important than the actual voltages. Furthermore, the voltage difference between the bus bars may be less than or greater than 50 V. Embodiments described herein are exemplary and not intended to limit the scope of the appended claims.

When controlling the tint profile of an electrochromic device in an insulated glass unit, a voltage profile can be applied to the bus bars of the electrochromic device to produce a desired tint level. A tint profile can be fully clear (highest transmission or fully bleached), fully tinted (lowest transmission state), or anything in between, such as a continuously graded transmission state or a substantially uniform transmission state across all of the areas of the electrochromic device. However, tinting a device in a continuously graded manner is dependent on several factors, of which one of the most important is being able to maintain electrical isolation in view of bus bar placement. With the complexities of bus bar designs in gradient electroactive devices, bus bar placements and electrical isolation placement have previously needed to be predetermined prior to manufacturing the electroactive device. The present disclosure has determined a method of forming a substrate for creating one or more electroactive devices capable of being tinted as a gradient without having to know or predetermine the location of each device on the substrate prior to making or manufacturing the substrate.

The present disclosure relates to a method of and substrate for creating one or more electroactive devices capable of being maintained at a continuously graded transmission state without predetermining the location of each device on the substrate.

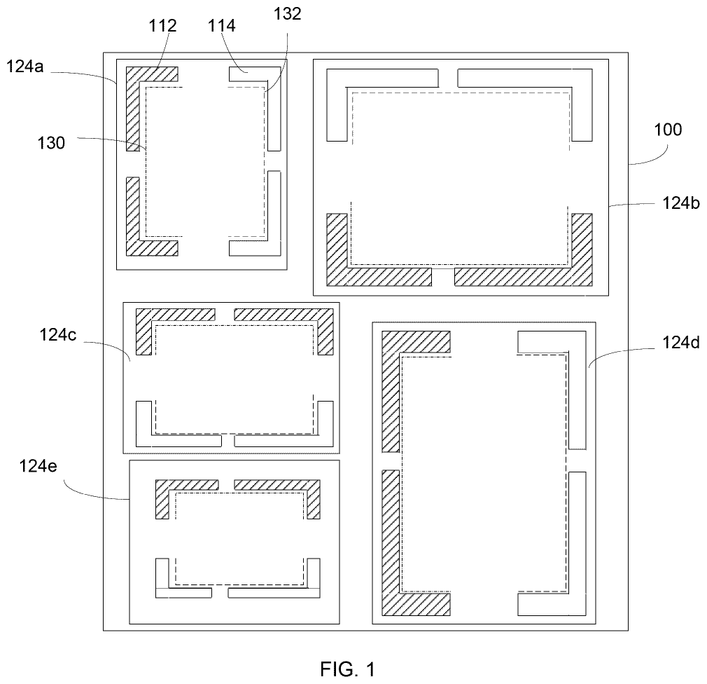

FIG. 1 includes an illustration of a top view of a previous manufacturing method of electroactive devices capable of being maintained at a continuously graded transmission state. The substrate 100 can contain one or more electroactive devices 124a, 124b, 124c, 124d, 124e prior to being separated. As seen in FIG. 1, the one or more electroactive devices can be of various sizes. Though not shown, the one or more electroactive devices can have varying shapes. The one or more electroactive devices 124a, 124b, 124c, 124d, 124e each contain a first isolation line 130, and a second isolation line 132 that help maintain electrical isolation between a first bus bar 112 and a second bus bar 114. With the complexities of the bus bar design and the need to maintain electrical isolation between the first bus bar 112 and the second bus bar 114, the placement of each of the one or more electroactive devices 124a, 124b, 124c, 124d, 124e is predetermined prior to manufacturing. Accordingly, the bus bar placement is also predetermined prior to manufacturing.

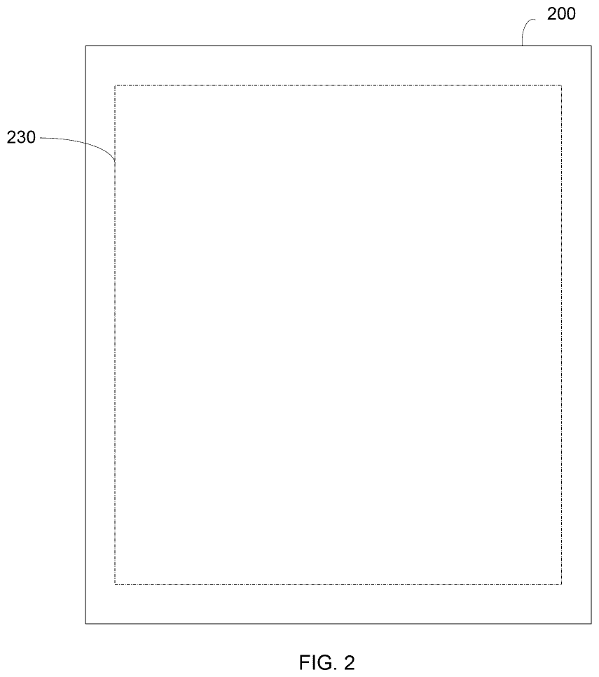

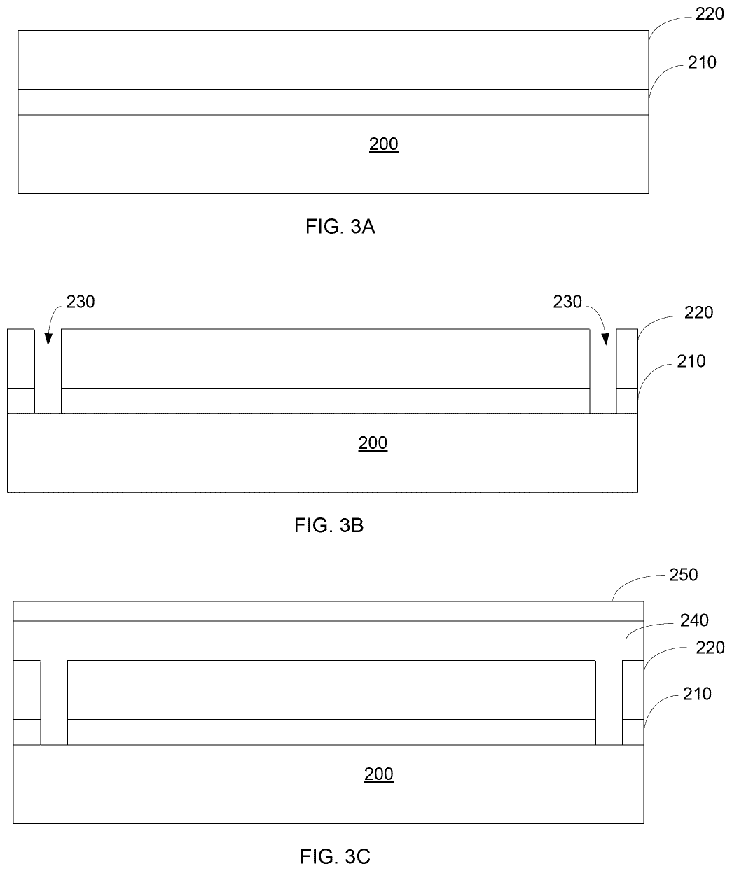

FIG. 2 includes an illustration of a top view of a substrate 200 for creating one or more electroactive devices capable of being maintained at a continuously graded transmission state, according to one embodiment. Manufacturing one or more electrochromic devices capable of being maintained at a continuously graded transmission state can include depositing specific layers of an electroactive device and producing a first isolation line 230 on a substrate 200. FIGS. 3A-3C include illustrations of cross-sections of a substrate 200 during manufacturing of one or more electroactive devices 224, according to one embodiment.

Many various shaped electroactive devices are disclosed in the U.S. Provisional Patent Application No. 62/786,603 which is incorporated herein in its entirety by this reference and each of the insulated glazing units, substrates, and electroactive devices, disclosed in this referenced provisional patent application can benefit from the aspects of this disclosure. While the disclosure describes specific layers of the electroactive devices capable of a gradient transmission state, the disclosure and methods described herein are applicable to any electroactive device with similar or comparable layers. The substrate 200 can be a motherboard capable of producing one or more electroactive devices. The substrate 200 can include a first isolation line 230. The first isolation line 230 can be continuous. In one embodiment, the isolation line 230 can be adjacent to a perimeter of the substrate. In one embodiment, the isolation line 230 can be continuous along all sides of the substrate 200. In one embodiment, the isolation line 230 can be in the same location from substrate to substrate. In other words, the isolation line 230 can be the only isolation line that is predetermined during manufacturing.

A method of manufacturing one or more electroactive devices 224 can begin by depositing a first conductive layer 210 and a first electroactive layer 220 on the substrate 200, as seen in FIG. 3A.

In one embodiment, the first conductive layer 210 can include a conductive metal oxide or a conductive polymer. Examples can include a indium oxide, tin oxide or a zinc oxide, either of which can be doped with a trivalent element, such as Sn, Sb, Al, Ga, In, or the like, or a sulfonated polymer, such as poly(3,4-ethylenedioxythiophene), or the like or sulfonated polyaniline and polypyrrole, or one or several metal layer(s) or a metal mesh or a nanowire mesh or graphene or carbon nanotubes or a combination thereof.

The substrate 200 can include a glass substrate, a sapphire substrate, an aluminum oxynitride substrate, a spinel substrate, or a transparent polymer. In a particular embodiment, the substrate 200 can be float glass or a borosilicate glass and have a thickness in a range of 0.025 mm to 8 mm thick. In another particular embodiment, the substrate 200 can include ultra-thin glass that is a mineral glass having a thickness in a range of 10 microns to 300 microns. In one embodiment, the first conductive layer 210 can be deposited on the substrate 200. In another embodiment, additional layers can be between the first conductive layer 210 and the substrate 200.

The first electroactive layer 220 can be a cathodic electroactive layer. In one embodiment, the first electroactive layer can be an electrode layer. In one embodiment, the first electroactive layer 220 can be an electrochromic layer. The first electroactive layer 220 can include an inorganic metal oxide electroactive active material, such as WO₃, V₂O₅, MoO₃, Nb₂O₅, TiO₂, CuO, Ir₂O₃, Cr₂O₃, Co₂O₃, Mn₂O₃, or any combination thereof and have a thickness in a range of 20 nm to 2000 nm.

The method of manufacturing can continue by creating a continuous electrical isolation line 230 in the first conductive layer 210, as seen in FIG. 3B. While FIG. 3A shows depositing a first electroactive layer 220 prior to creating the electrical isolation line 230, in one embodiment, the first electroactive layer 220 can be deposited after creating the electrical isolation line 230. In one embodiment, the electrical isolation line 230 can be substantially around an entire perimeter of the substrate 200, as seen in FIG. 2A. In an embodiment, creating the electrical isolation line 230 can be performed with a full spectrum laser. In a more particular embodiment, the laser can be operated with a pulse duration between 200 fs and 10 fs, between 250 fs and 1250 fs, or between 300 fs and 1000 fs. Use of a short laser pulse can prevent intermixing or melting between the first electroactive layer 220 and the first conductive layer 210 thereby maintaining the electroactive device in a functional state. In yet a more particular embodiment, the laser is operated with a wavelength between 450 nm and 600 nm, between 500 nm and 550 nm, or between 510 nm and 525 nm. In an embodiment, the laser can be operated with a variable pulse duration, a variable wavelength, or a combination thereof.

The method of manufacturing can continue by depositing a second electroactive layer 240 and a second conductive layer 250 over the formed first conductive layer 210. The second electroactive layer 240 can be an anodic electroactive layer. The second electroactive layer 240 can be an electrode layer. In one embodiment, the second electroactive layer 240 can be a counter electrode layer. The second electroactive layer 240 can include an inorganic metal oxide electroactive active material, such as WO₃, V₂O₅, MoO₃, Nb₂O₅, TiO₂, CuO, Ir₂O₃, Cr₂O₃, Co₂O₃, Mn₂O₃, or any combination thereof and have a thickness in a range of 20 nm to 2000 nm. The second electroactive layer 240 may further include nickel oxide (NiO, Ni₂O₃, or a combination of the two) or iridium oxide, and Li, Na, H, or another ion and have a thickness in a range of 20 nm to 1000 nm.

The second conductive layer 250 can include a conductive metal oxide or a conductive polymer. Examples can include an indium oxide, tin oxide or a zinc oxide, either of which can be doped with a trivalent element, such as Sn, Sb, Al, Ga, In, or the like, or a sulfonated polymer, such as poly(3,4-ethylenedioxythiophene), or the like or sulfonated polyaniline and polypyrrole, or one or several metal layer(s) or a metal mesh or a nanowire mesh or graphene or carbon nanotubes or a combination thereof. The first and second conductive layers 210 and 250 can have the same or different compositions.

The one or more devices can include additional layers not shown. In one embodiment, additional layers can be deposited between the substrate 200 and the first conductive layer 210. In one embodiment, additional layers can be deposited over the second conductive layer 250. In one embodiment, the substrate can include an ion conducting layer between the first electroactive layer 220 and the second electroactive layer 240. In one embodiment, the ion conducting layer, the first electroactive layer 220 and the second electroactive layer 240 can be between the first conductive layer 210 and the second conductive layer 250. The ion conductive layer (sometimes called an electrolyte layer) can be optional and can have a thickness in a range of 1 nm to 1000 nm in the case of an inorganic ion conductor or 5 microns to 1000 microns in the case of an organic ion conductor. The ion conductive layer can include a silicate with or without lithium, aluminum, zirconium, phosphorus, boron; a borate with or without lithium; a tantalum oxide with or without lithium; a lanthanide-based material with or without lithium; another lithium-based ceramic material particularly LixMOyNz where M is one or a combination of transition metals or the like.

Although not shown, a second substrate can be on top of the second conductive layer 250. The first substrate 200 and the second substrate can each include a glass substrate, a sapphire substrate, an aluminum oxynitride substrate, a spinel substrate, or a transparent polymer. The first substrate 200 and the second substrate can have the same or different compositions.

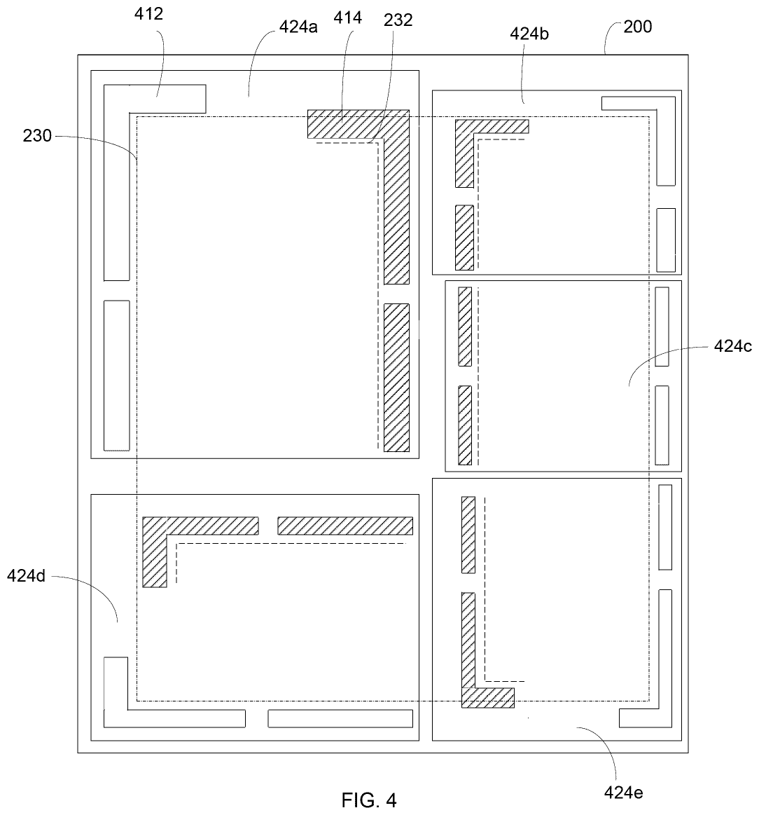

The substrate 200 can further be processed into one or more electroactive devices capable of being maintained at a continuously graded transmission state. In one embodiment, additional processing can include adding one or more bus bars or one or more isolation cuts. In one embodiment, the additional processing can happen at a second location different from the deposition of the layers up until the second conductive layer 250, as described above. The one or more electroactive devices can in turn be further processed into a laminate device or an insulated glazing unit. In one embodiment, the substrate 200 with the formed isolation line 230 can be stored for a period of time prior to further processing. In one embodiment, the substrate 200 with the formed isolation line 230 can be stored for a period of time from between about 1 day to 5 years. In one embodiment, the substrate 200 with the formed isolation line 230 can be shipped to a second location for additional processing. In one embodiment, the substrate 200 with the formed isolation line 230 can be stored for a period of time and then shipped to a second location for additional processing. In one embodiment, the method of manufacturing one or more electroactive devices can include determining the shape, size, and location of the one or more electroactive devices on the substrate 200 after forming the substrate 200 and electrical isolation line 230. As seen in FIG. 4, the one or more electroactive devices 424a, 424b, 424c, 424d, 242e each include a portion of the electrical isolation line 230 and can include a first bus bar 412 and a second bus bar 414. A second isolation line 232 can be added at a later stage in manufacturing of the one or more electroactive devices. The bus bar can be adjacent to or on the continuous electrical isolation line 230. The isolation line 230 electrically isolates the first bus bar 412 from the second bus bar 414 and prevents a short in the electroactive device 424. In one embodiment, the one or more electroactive devices 424a, 424b, 424c, 424d, 424e include the layers as described above. The one or more electroactive devices can each be tinted as a gradient or in other words be maintained at a continuously graded transmission state.

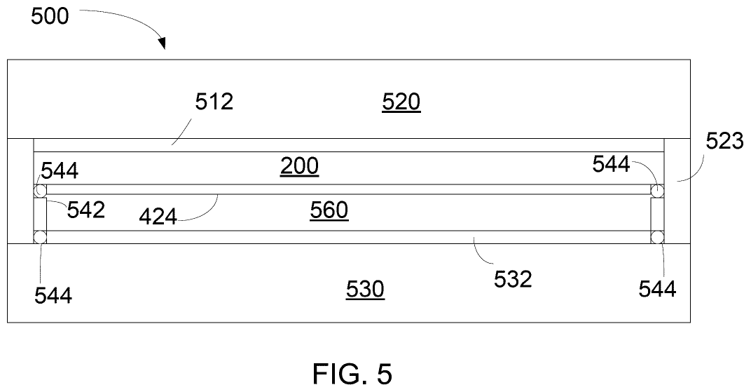

FIG. 5 includes an illustration of a cross-sectional view of an insulated glass unit (IGU) 500. The insulated glass unit (IGU) 500 can include a substrate 200 and the electrochromic device 424 as illustrated in FIG. 4. The IGU 500 can further include a support substrate 520 and a solar control film 512 disposed between the electrochromic device 424 and the support substrate 520. The support substrate 520 can be coupled to a pane 530. Each of the support substrate 520 and pane 530 can be a toughened or a tempered glass and have a thickness in a range of 2 mm to 9 mm. A low-emissivity layer 532 can be disposed along an inner surface of the pane 530. The support substrate 520 and pane 530 can be spaced apart by a spacer bar 542. The spacer bar 542 can be coupled to the support pane 530 and substrate 200 via seals 544. The seals 544 can be a polymer, such as polyisobutylene. An adhesive joint 523 is designed to hold the support substrate 520 and the pane 530 together and is provided along the entire circumference of the edges of the support substrate 520 and the pane 530. The adhesive joint 523 can include silicone. An internal space 560 of the IGU 500 may include a relatively inert gas, such as a noble gas or dry air. In another embodiment, the internal space 560 may be evacuated.

The IGU can include an energy source, a control device, and an input/output (I/O) unit. The energy source can provide energy to the electrochromic device 424 via the control device. In an embodiment, the energy source may include a photovoltaic cell, a battery, another suitable energy source, or any combination thereof. The control device can be coupled to the electrochromic device and the energy source. The control device can include logic to control the operation of the electrochromic device. The logic for the control device can be in the form of hardware, software, or firmware. In an embodiment, the logic may be stored in a field programmable gate array (FPGA), an application-specific integrated circuit (ASIC), or another persistent memory. In an embodiment, the control device may include a processor that can execute instructions stored in memory within the control device or received from an external source. The I/O unit can be coupled to the control device. The I/O unit can provide information from sensors, such as light, motion, temperature, another suitable parameter, or any combination thereof. The I/O unit may provide information regarding the electrochromic device 424, the energy source, or control device to another portion of the apparatus or to another destination outside the apparatus.

It should be understood that any of the preceding embodiments can yield a tint profile that can be fully clear (highest transmission or fully bleached), fully tinted (lowest transmission state), a continuously graded transmission state (with a portion being bleached towards a portion in the highest transmission state) or anything in between. The tint profile can also be a substantially uniform transmission state across all of the area of the electrochromic device 424, a continuously graded transmission state across all of the area of the electrochromic device 424, or with a combination of a portion with a substantially uniform transmission state and another portion with a continuously graded transmission state.

Many different aspects and embodiments are possible. Some of those aspects and embodiments are described below. Exemplary embodiments may be in accordance with any one or more of the ones as listed below.

### EMBODIMENTS

Embodiment 1. A method of manufacturing one or more electroactive devices, the method can include: creating a continuous electrical isolation line in a first conductive layer around substantially an entire perimeter of a substrate; and depositing an electroactive material and a second conductive layer over the formed first conductive layer to form one or more electroactive devices on the substrate.

Embodiment 2. The method of embodiment 1, where the one or more electroactive devices can be configured to be maintained at a continuously graded transmission state.

Embodiment 3. The method of embodiment 2, where the one or more electroactive devices do not have a predetermined location on the substrate.

Embodiment 4. The method of embodiment 1, where the one or more electroactive devices do not have a predetermined location on the substrate.

Embodiment 5. The method of embodiment 1, further includes forming more than one electroactive device on the substrate.

Embodiment 6. The method of embodiment 1, where a laser creates the continuous isolation line in the first conductive layer.

Embodiment 7. The method of embodiment 1, where the laser removes a portion of the first conductive layer.

Embodiment 8. The method of embodiment 1, further includes depositing a first bus bar adjacent to or on the continuous electrical isolation line, where the continuous electrical isolation line isolates the bus bar from creating a short in the one or more electroactive devices.

Embodiment 9. The method of embodiment 8, where the first bus bar is electrically connected to the second conductive layer.

Embodiment 10. The method of embodiment 9, further includes depositing a second bus bar, where the second bus bar is electrically connected to the first conductive layer.

Embodiment 11. The method of embodiment 1, further includes cutting the substrate to separate the one or more electroactive devices.

Embodiment 12. The method of embodiment 1, where placing the electroactive material and the second conductive layer over the formed first conductive layer and the continuous isolation line comprises depositing the electroactive material over the first conductive layer, where the continuous electrical isolation line comprises the electroactive material.

Embodiment 13. The method of embodiment 1, further includes determining the shape, size, and location of the one or more electroactive devices on the substrate after forming the continuous electrical isolation line.

Embodiment 14. The method of embodiment 8, where each of the one or more electroactive devices includes a portion of the continuous electrical isolation line.

Embodiment 15. The method of embodiment 1, where the electroactive material is selected from the group consisting of an inorganic metal oxide electroactive active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, and any combination thereof.

Embodiment 16. The method of embodiment 8, further includes moving the substrate to a second location prior to depositing the first bus bar.

Embodiment 17. A substrate for manufacturing one or more electroactive devices, can include: a continuous electrical isolation line in a first conductive layer; where the continuous electrical isolation line is around substantially an entire perimeter of the substrate; and one or more electroactive devices do not have a predetermined location, where each of the one or more electroactive devices can include: a portion of the continuous electrical isolation line in the first conductive layer.

Embodiment 18. The substrate of embodiment 17, where the one or more electroactive devices are each configured to be tinted as a gradient.

Embodiment 19. The substrate of embodiment 17, where each of the one or more electroactive devices further comprise an electroactive material and a second conductive layer over the formed first conductive layer.

Embodiment 20. The substrate of embodiment 17, where the portion of the continuous electrical isolation line isolates a first bus bar from a second bus bar.

While the present disclosure may be susceptible to various modifications and alternative forms, specific embodiments have been shown by way of example in the drawings and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any sub-combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub-combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of manufacturing one or more electroactive devices, the method comprising:
creating a continuous electrical isolation line in a first conductive layer around substantially an entire perimeter of a substrate; and
depositing an electroactive material and a second conductive layer over the formed first conductive layer to form one or more electroactive devices on the substrate.

2. The method of claim 1, wherein the one or more electroactive devices are configured to be maintained at a continuously graded transmission state.

3. The method of claim 2, wherein the one or more electroactive devices do not have a predetermined location on the substrate.

4. The method of claim 1, wherein the one or more electroactive devices do not have a predetermined location on the substrate.

5. The method of claim 1, further comprising forming more than one electroactive device on the substrate.

6. The method of claim 1, wherein a laser creates the continuous isolation line in the first conductive layer.

7. The method of claim 1, wherein the laser removes a portion of the first conductive layer.

8. The method of claim 1, further comprising depositing a first bus bar adjacent to or on the continuous electrical isolation line, wherein the continuous electrical isolation line isolates the bus bar from creating a short in the one or more electroactive devices.

9. The method of claim 8, wherein the first bus bar is electrically connected to the second conductive layer.

10. The method of claim 9, further comprising depositing a second bus bar, wherein the second bus bar is electrically connected to the first conductive layer.

11. The method of claim 1, further comprising cutting the substrate to separate the one or more electroactive devices.

12. The method of claim 1, wherein placing the electroactive material and the second conductive layer over the formed first conductive layer and the continuous isolation line comprises depositing the electroactive material over the first conductive layer, wherein the continuous electrical isolation line comprises the electroactive material.

13. The method of claim 1, further comprising determining the shape, size, and location of the one or more electroactive devices on the substrate after forming the continuous electrical isolation line.

14. The method of claim 8, wherein each of the one or more electroactive devices includes a portion of the continuous electrical isolation line.

15. The method of claim 1, wherein the electroactive material is selected from the group consisting of an inorganic metal oxide electroactive active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, and any combination thereof.

16. The method of claim 8, further comprising moving the substrate to a second location prior to depositing the first bus bar.

17. A substrate for manufacturing one or more electroactive devices, comprising:
a continuous electrical isolation line in a first conductive layer; wherein the continuous electrical isolation line is around substantially an entire perimeter of the substrate; and
one or more electroactive devices do not have a predetermined location, wherein each of the one or more electroactive devices comprise:
a portion of the continuous electrical isolation line in the first conductive layer.

18. The substrate of claim 17, wherein the one or more electroactive devices are each configured to be tinted as a gradient.

19. The substrate of claim 17, wherein each of the one or more electroactive devices further comprise an electroactive material and a second conductive layer over the formed first conductive layer.

20. The substrate of claim 17, wherein the portion of the continuous electrical isolation line isolates a first bus bar from a second bus bar.
